(19) United States
(12) Patent Application Publication
(10) Pub. No.: US 2013/0233623 A1
(43) Pub. Date: Sep. 12, 2013

(54) CONSOLIDATION

(71) Applicants: Mark Shelton Aston, Middlesex (GB); Dana Aytkhozhina, Middlesex (GB)

(72) Inventors: Mark Shelton Aston, Middlesex (GB); Dana Aytkhozhina, Middlesex (GB)

(73) Assignee: BP Exploration Operating Company Limited, Middlesex (GB)

(21) Appl. No.: 13/885,350

(22) PCT Filed: Nov. 22, 2011
(86) PCT No.: PCT/GB2011/001638

§ 371 Date: May 14, 2013

(30) Foreign Application Priority Data
Nov. 25, 2010 (EP) 10252006.1

(51) Int. Cl. C09K 8/08; E21B 21/00

(52) U.S. Cl. CPC C09K 8/08; E21B 21/00
USPC 175/65; 507/140

(57) ABSTRACT

A method of strengthening subterranean formation by drilling and completing a wellbore penetrating at least one unconsolidated or weakly consolidated formation, the method comprising: (a) drilling at least one interval of the wellbore that penetrates the unconsolidated or weakly consolidated formation using a drilling mud comprising a base fluid comprising an aqueous phase containing up to 25% weight by volume (% w/v) of a water soluble silicate, wherein the drilling mud has an acid-soluble particulate bridging solid suspended therein that is formed from a salt of a multivalent cation, wherein the salt of the multivalent cation is capable of providing dissolved multivalent cations when in the presence of an acid; (b) subsequently introducing a breaker fluid containing an acid and/or an acid precursor into the wellbore; (c) allowing the breaker fluid to soak in the interval that penetrates the unconsolidated or weakly consolidated formation for a predetermined period and strengthening formation by reacting with silicate now present in formation; and (d) removing the breaker fluid.

This invention relates to the consolidation of fine particulate matter, e.g. silt or sand. Particularly, the invention relates to the consolidation of unconsolidated or weakly consolidated zones within subterranean formations comprising such particulate matter, especially hydrocarbon-bearing formations. More particularly, the invention relates to the consolidation of unconsolidated or weakly consolidated formations that are penetrated by wellbores. In particular, the invention relates to the consolidation of unconsolidated or weakly consolidated formations that are penetrated by wellbores, where the consolidation is incorporated into routine drilling and completion operations.

When recovering hydrocarbons from subterranean formations containing particulate fines such as silt or sand particles, these particulates have a tendency to be displaced, for example due to instability of the formation. Where a large volume of fluid is forced to flow through such a formation, the very fine particles (especially sand) may be transported to the surface and must then he disposed of Disposal of large volumes of sand produced from unconsolidated or weakly consolidated formations presents serious problems in terms of the logistics of disposal. Erosion of downhole equipment such as tubulars, sandscreens, pumps, or valves owing to the high velocities of particulates, especially sand particles, can also occur. Repair or replacement of such equipment can only be carried out during periods of shut-down in production.

Fine particulates can also become lodged in the pores of the formation, in particular, the pore throats in an intergranular rock (the small pore space at the point where two grains of an intergranular formation meet, which connects two larger pore volumes). This at least partially plugs the pores of the formation thereby causing a reduction in permeability of the formation and hence a reduction in the rate of hydrocarbon production.

The production and movement of fine particulates, especially sand particles, is a major problem in the operation of hydrocarbon production wells, particularly those that penetrate unconsolidated or weakly consolidated formations. Loss of production may arise owing to plugging of gravel packs, sand screens, perforations, tubulars, surface flow lines or separators. In addition to damaging pumps or other downhole equipment, erosion of casing, tubulars, downhole equipment and equipment in surface facilities may also occur. This erosion can in some cases cause loss of a well owing to hole collapse or may require re-completion of the well (replacement of casing, tubulars, and downhole equipment). Accordingly, there is a need for effective sand control.

Mechanical means for preventing sand grains from entering wellbores are known and are widely used. However, the use of such mechanical means can involve high costs and/or complexity.

Various chemical approaches have been developed. For instance, chemical approaches using fluids incorporating silicate-based chemistry are known. However, these fluids are typically used only after a well has been drilled, and completed such that the well may have already experienced sand production. Further, this approach often results in complications with proper placement of the chemical consolidation treatment, especially where there are long intervals of varying permeabilities.

It would clearly be advantageous to incorporate consolidation chemicals into “drill-in” fluids, i.e. fluids used when drilling into a hydrocarbon-bearing formation. For instance, this may enable consolidation to be achieved during routine drilling and completion operations.

However, known fluids incorporating silicate-based chemistry have not generally been considered suitable for use as “drill-in” fluids, primarily because the risk of “formation damage” tends to be too great.

Industry experience shows that it is very difficult to effectively consolidate intervals with varying permeability profiles by chemical means alone—typically, mechanical means, e.g. isolation means will also be required. The use of mechanical means adds further costs to the operation. The incorporation of consolidation chemicals in “drill-in” fluids may also permit an even distribution of the chemicals over long, heterogeneous intervals to be achieved, thereby avoiding or at least reducing the need to also utilise mechanical means.

A first aspect of the invention provides a method of drilling and completing a wellbore penetrating at least one unconsolidated or weakly consolidated formation, the method comprising:
(a) drilling at least one interval of the wellbore that penetrates the unconsolidated or weakly consolidated formation using a drilling mud comprising a base fluid comprising an aqueous phase containing up to 25% weight by volume (% w/v) of a water soluble silicate, wherein the drilling mud has an acid-soluble particulate bridging solid suspended therein that is formed from a salt of a multivalent cation, wherein the salt of the multivalent cation is capable of providing dissolved multivalent cations when in the presence of an acid;
(b) subsequently introducing a breaker fluid containing an acid and/or an acid precursor into the wellbore;
(c) allowing the breaker fluid to soak in the interval that penetrates the unconsolidated or weakly consolidated formation for a predetermined period; and
(d) removing the breaker fluid.

In step (a) of the method of the present invention, the base fluid leaks off into the unconsolidated or weakly consolidated formation and a filter cake comprising acid-soluble particulate bridging solid forms on the wall of the wellbore. In order to ensure that this will occur, the hydrostatic pressure in the wellbore adjacent the unconsolidated or weakly consolidated formation should exceed the formation pressure.

Typically, in step (b) of the method of the present invention, the hydrostatic pressure in the wellbore adjacent the unconsolidated or weakly consolidated formation should also exceed the formation pressure such that the breaker fluid may leak off into the formation, thereby causing gelling of the silicate solution that has previously leaked off into the formation from the drilling mud. In addition, the breaker fluid may react with the particulate bridging solid contained within the filter cake, thereby dissolving the particles and generating dissolved multivalent cations. These multivalent cations together with any multivalent cations that are present within the formation water may react with the silicate that is present in the formation resulting in a water insoluble precipitate.

The method is especially suitable for open hole drilling and completion operations.

Typically, the or each unconsolidated or weakly consolidated formation may comprise particulates, i.e. grains of the formation rock that is to be consolidated, having a mean particle diameter of less than 1 mm, for example, less than 150 μm. Many different materials can be found in subterranean formations and thus the composition of the particulates may vary widely. In general, the particulates may include quartz and other minerals, clays, and siliceous materials such as sand. The methods and compositions described herein may find particular use in treating sandstone formations, i.e. sand particles.

After consolidation of the formation, the method may comprise drilling one or more further intervals of the wellbore. If a further interval of wellbore penetrates an unconsolidated or weakly consolidated formation, the formation adjacent this further interval of wellbore may also be consolidated using the method of the present invention.

Alternatively, the whole wellbore may be drilled before introducing the breaker fluid to consolidate the or each unconsolidated or weakly consolidated formation that is penetrated by the wellbore.

Preferably, the drilling mud may be a drill-in fluid, by which is meant a fluid used to drill into a hydrocarbon-producing zone.

The drilling mud may be displaced from the interval that penetrates the unconsolidated or weakly consolidated formation by the breaker fluid. Alternatively, a spacer fluid may be used to displace the drilling mud and the spacer fluid is then subsequently displaced by the breaker fluid. The spacer fluid may be the base fluid without any particulate bridging solid, or a synthetic brine or a naturally occurring brine.

The predetermined period during which the breaker fluid soaks in the interval that penetrates the unconsolidated or weakly consolidated formation may be up to 10 days, e.g. from one to seven days.

Preferably, the base fluid may be water-based (100% aqueous phase) or an oil-in-water emulsion having a continuous aqueous phase and a discontinuous oil phase. The water used to prepare the base fluid may be fresh water, brackish water, or a brine such as seawater or a saline aquifer water. One or more density increasing salts may be added to the water, thereby generating a synthetic brine. The density increasing salts may be present in the synthetic brine at concentrations up to saturation. Where the aqueous phase is either a synthetic brine or a naturally occurring brine, it is preferred that the density increasing salt in the brine is present at a concentration in the range 0.5 to 25% by weight, e.g. in the range of 3 to 15% by weight, based on the total weight of the brine. Typical density increasing salts that may be added to the water to generate a synthetic brine include Group I metal halides and formates, for example, sodium chloride, potassium chloride, sodium bromide, potassium bromide, sodium formate, and potassium formate.

In an emulsion, the discontinuous oil phase may be dispersed in the continuous aqueous phase in an amount of from 1 to 65% by volume, preferably 2.5 to 40% by volume, most preferably 10 to 35% by volume, based on the total volume of the aqueous and oil phases. Generally, the oil may be present in the form of finely divided droplets.

Suitably, the droplets may have an average diameter of less than 40 microns, preferably between 0.5 and 20 microns, and most preferably between 0.5 and 10 microns. The oil phase of the emulsion may comprise a crude oil, a refined petroleum fraction, a mineral oil, a synthetic hydrocarbon, or any suitable non-hydrocarbon oil. Any non-hydrocarbon oil that is capable of forming a stable emulsion with the aqueous phase may be used. Preferably, such a non-hydrocarbon oil may be biodegradable and, therefore, may not be associated with ecotoxic problems. It is particularly preferred that such a non-hydrocarbon oil has a solubility in water at room temperature of less than 2% by weight, preferably less than 1% by weight, most preferably, less than 0.5% by weight.

Suitably, the non-hydrocarbon oil may be selected from the group consisting of polyalkylene glycols, esters, acetals, synthetic hydrocarbons, ethers and alcohols.

Suitable polyalkylene glycols include polypropylene glycols (PPG), polybutylene glycols, and polytetrahydrofurans. Preferably, the molecular weight of the polyalkylene glycol should be sufficiently high that the polyalkylene glycol has a solubility in water at room temperature of less than 2% by weight. The polyalkylene glycol may also be a copolymer of at least two alkylene oxides, e.g. selected from the group consisting of ethylene oxide, propylene oxide and butylene oxides. Where ethylene oxide is employed as a comonomer, the mole percent of units derived from ethylene oxide shall be limited such that the solubility of the copolymer in water at room temperature is less than 2% by weight. The person skilled in the art would be able to readily select polyalkylene glycols that exhibit the desired low-water solubility.

Suitable esters include esters of unsaturated fatty acids and saturated fatty acids as disclosed in EP 037467-1A and EP 0374672 respectively; esters of neo-acids as described in WO 93/23491; oleophilic carbonic acid diesters having a solubility of at most 1% by weight in water (as disclosed in U.S. Pat. No. 5,461,028); triglyceride ester oils such as rapeseed oil (see U.S. Pat. No. 4,631,136 and WO 95/26386). Suitable acetals are described in WO 93116145. Suitable synthetic hydrocarbons include polyalphaolefins (see, for example, EP 0325466A, EP 0449257A, WO 94/16030 and WO 95/09215); isomerized linear olefins (see EP 0627481A, U.S. Pat. No. 5,627,143, U.S. Pat. No. 5,432,152 and WO 95/21225); n-paraffins, in particular n-alkanes (see, for example, U.S. Pat. No. 4,508,628 and U.S. Pat. No. 5,846,913); linear alkyl benzenes and alkylated cycloalkyl fluids (see GB 2,258,258 and GB 2,287,049 respectively). Suitable ethers include those described in EP 0391251A (ether-based fluids) and U.S. Pat. No. 5,990,050 (partially water soluble glycol ethers). Suitable alcohols include oleophilic alcohol-based fluids as disclosed in EP 0391252A. Suitable emulsifiers for forming oil-in-water emulsions are well known to the person skilled in the art.

Preferably, over-balanced drilling may be employed, in order to ensure that at least a portion of the aqueous phase that contains the silicate enters (leaks off into) the or each weakly consolidated interval. Thus, the density of the drilling mud may be selected such that the hydrostatic pressure in the wellbore adjacent the weakly consolidated formation exceeds the pressure in the pore space of the weakly consolidated formation. The density of the drilling mud may be adjusted by adjusting the concentration of water soluble salts in the aqueous phase or by addition of weighting agents to the drilling mud. It is observed that the particulate bridging solid may also serve as a weighting agent.

Preferably, the water soluble silicate may be an alkali metal silicate, for example, a sodium or a potassium silicate.

Typically, the water soluble silicate may be a sodium silicate of the formula [Na₂O]x[SiO₂]y, where the ratio of y to x is in the range of from 2:1 to 7:2, preferably from 2:1 to 17:5, e.g. 3:1.

The aqueous phase of the base fluid contains up to 25% w/v, preferably, up to 20% w/v, more preferably, up to 17.5% w/v, in particular, up to 15% w/v of the water soluble silicate. Preferably, the aqueous phase of the base fluid contains at least 3% w/v, in particular, at least 5% w/v of water soluble silicate.

The drilling mud may comprise additional additives for improving its performance with respect to one or more properties. Examples of additives that may be added include viscosifiers, weighting agents, density increasing water soluble salts (as discussed above), fluid loss control agents (also known as filtration control additives), pH control agents, clay or shale hydration inhibitors (such as polyalkylene glycols), bactericides, surfactants, solid and liquid lubricants, gas-hydrate inhibitors, corrosion inhibitors, defoamers, scale inhibitors, emulsified hydrophobic liquids such as oils (as discussed above), acid gas-scavengers (such as hydrogen sulphide scavengers), thinners (such as lignosulfonates), demulsifiers and surfactants designed to assist the clean-up of invaded fluid from producing formations.

Water soluble polymers may be added to the drilling mud to impart viscous properties, solids-dispersion and filtration control to the fluid. A wide range of water soluble polymers may be used including cellulose derivatives such as carboxymethyl cellulose, hydroxyethyl cellulose, carboxymethylhydroxyethyl cellulose, sulphoethyl cellulose; starch derivatives (which may be cross-linked) including carboxymethyl starch, hydroxyethyl starch, hydroxypropyl starch; bacterial gums including xanthan, welan, diutan, succinoglycan, scleroglucan, dextran, pullulan; plant derived gums such as guar and locust-bean gums and their derivatives; synthetic homopolymers and copolymers derived from any suitable monomers including monomers selected from the group consisting of acrylic acid or methacrylic acid and their hydroxylic esters (for example, hydroxyethylmethacrylic acid), maleic anhydride or maleic acid, sulphonated monomers such as styrenesulphonic acid and AMPS, acrylamide and substituted acrylamides, N-vinylformamide and N-vinylacetamide, N-vinylpyrrolidone, vinyl acetate, N-vinylpyridine and other cationic vinylic monomers (for example, diallydimethylammonium chloride, DADMAC); and any other water soluble or water-swellable polymers known to those skilled in the art.

Generally, viscosifying water soluble polymers may be present in the drilling mud in an amount sufficient to maintain the bridging solid and optional weighting solids in suspension and provide efficient clean out from the wellbore of debris such as drilled cuttings. The viscosifying polymer may be present in the drilling mud in an amount in the range of 0.2 to 5 pounds of viscosifier per barrel (ppb) of drilling mud, preferably 0.5 to 3 pounds per barrel of drilling mud.

Rheological control (for example, gelling properties) can also be provided to the drilling mud by adding clays and/or other inorganic fine particles. Examples include bentonite, montmorillonite, hectorite, attapulgite, sepiolite, Laponite™ (ex Laporte) and mixed metal hydroxides.

Fluid loss control agents may be included in the drilling mud to prevent unacceptable loss of the aqueous phase of the drilling mud into the formations penetrated by the wellbore. Thus, the fluid loss control agents may provide filtration control.

Suitable fluid loss agents that may be incorporated in the drilling mud include organic polymers of natural and/or synthetic origin. Suitable polymers include starch or chemically modified starches; cellulose derivatives such as carboxymethyl cellulose and polyanionic cellulose (PAC); guar gum and xanthan gum; homopolymers and copolymers of monomers selected from the group consisting of acrylic acid, acrylamide, acrylamido-2-methyl propane sulphonic acid (AMOS), styrene sulphonic acid, N-vinyl acetamide, N-vinyl pyrrolidone, and N,N-dimethylacrylamide wherein the copolymer has a number average molecular weight of from 100,000 to 1,000,000; asphalts (for example, sulfonated asphalts); gilsonite; lignite (humic acid) and its derivatives; lignin and its derivatives such as lignin sulfonates or condensed polymeric lignin sulfonates; and combinations thereof. Any of these polymers that contain acidic functional groups are preferably employed in the neutralised form, e.g. as sodium or potassium salts. As an alternative to, or in addition to, employing such additives, the fluid loss when using the drilling mud may be reduced by adding finely dispersed particles such as clays (for example, illite, kaolinite, bentonite, hectorite or sepiolite).

The amount of fluid loss control agent that is included in the drilling mud is preferably sufficient to ensure that the drilling mud has a fluid loss in the range of 2 to 20 ml/30 minutes in low pressure fluid loss tests performed according to the specifications of the American Petroleum Institute (API), as described in “Recommended Practice Standard Procedure for Field Testing Water-Based Drilling Fluids”, API Recommended Practice 13B-1, Forth Edition, February 2009.

Typically, the amount of fluid loss control agent that is included in the drilling mud is in the range of 3 to 10 ppb, preferably 5 to 9 ppb, in particular 7 to 9 ppb.

The amount of fluid loss control agent may need to be reduced in comparison with conventional muds as it is essential that filtrate containing the water soluble silicate enters the pore space of the unconsolidated or weakly consolidated formation.

Typically, the treatment zone for the unconsolidated or weakly consolidated formation extends a radial distance of up to 30 feet from the wall of the wellbore, for example, 1 to 10 feet from the wall of the wellbore. Thus, the drilling mud filtrate (base fluid that comprises an aqueous phase containing up to 25% w/v, preferably, up to 20% w/v of a water soluble silicate) may travel a radial distance of up to 30 feet into the formation. Similarly, the breaker fluid may travel a radial distance of up to 30 feet into the formation.

Suitably the pH of the drilling mud is maintained above 7, preferably, above 9, more preferably, above 10, for example, above 12, so as to avoid premature gelling of the water soluble silicate in the wellbore during drilling of the wellbore. Suitable pH control agents for the drilling mud may include caesium hydroxide, strontium hydroxide, lithium hydroxide, sodium hydroxide, potassium hydroxide, rubidium hydroxide, sodium carbonate, sodium bicarbonate, potassium bicarbonate, and the like. A pH buffer may also be used, for example, borax and sodium hydroxide having a pH range for the buffer of 9.2 to 11.

The particulate bridging solid may be comprised of an ionic compound having a multivalent cation, e.g. a divalent cation such as Mg²⁺ or Ca²⁺. Preferably, the particulate bridging solid is a carbonate of a multivalent cation such that the particulate bridging solid generates CO₂ in the presence of an acid.

Preferably, the particulate bridging solid may comprise a carbonate selected from calcium carbonate and/or magnesium carbonate and/or dolomite (calcium magnesium carbonate).

The silicate may be added to the aqueous phase of the base fluid as a concentrate, preferably having a silicate, e.g. sodium silicate, concentration of no more than about 39% w/v.

The breaker fluid may be aqueous, e.g. an aqueous solution of the acid and/or acid precursor. It may be preferred that the breaker fluid contains density increasing salts. It is envisaged that the amount of density increasing salts in the breaker fluid is sufficient to ensure that the hydrostatic pressure of the breaker fluid in the interval of the wellbore adjacent the unconsolidated or weakly consolidated formation exceeds the formation pressure such that the aqueous solution of the acid and/or acid precursor leaks-off into the formation where the acid gels the water soluble silicate that is present in the pore space of the formation. Thus, the breaker fluid may have a similar density to the drilling mud.

Preferred density increasing salts include those listed above for the drilling mud. However, it is also envisaged that the pumping pressure of the breaker fluid may be adjusted such that the breaker fluid is squeezed into the formation.

The acid may be a strong or weak acid. Suitable acids include mineral acids such as hydrochloric acid and sulphuric acid or organic acids, generally aliphatic carboxylic acids having from 1 to 6 carbon atoms, for example, formic acid, acetic acid and lactic acid (hydroxyacetic acid). Formic acid is a stronger acid than acetic acid and may be preferred. The concentration of acid in the breaker fluid is typically at least 5% by weight, for example, a concentration in the range of 5 to 20% by weight, preferably from 5 to 15% by weight (based on the total weight of the breaker fluid).

The acid precursor (i.e. acid generating substance) may be an ester or an orthoformate that hydrolyzes to produce an acid. Suitable esters for use as acid precursors include carboxylic acid esters, in particular esters of a carboxylic acid having from 1 to 6 carbon atoms and an alcohol or polyol. Typical esters include esters of a carboxylic acid selected from formic acid, acetic acid and lactic acid and an alcohol or polyol selected from methanol, ethanol, isopropanol, glycerol (1,2,3-propane triol), ethylene glycol, diethylene glycol, or triethylene glycol. Preferred esters include methyl acetate, methyl formate, ethyl acetate, ethyl formate, glyceryl triacetate, methyl lactate, glyceryl diacetate, ethylene glycol diacetate, diethylene glycol diacetate or triethylene glycol diacetate. Cyclic esters may also be used such as lactones, in particular β-propiolactone. Preferred orthoformates include triethylorthoformate, HC(OC₂H₅)₃, and triisopropylorthoformate, HC[OCH(CH₃)₂]₃. The ester or orthoformate should be at least slightly soluble in water. Preferably, the ester or orthoformate should have a solubility in water of at least 1% by weight, most preferably, at least 5% by weight.

In general, where the temperature in the wellbore is below 120° C., it may be preferred to incorporate an enzyme into the breaker fluid, in order to accelerate the rate of hydrolysis of the ester. Lipases, esterases and proteases may be the preferred enzymes for increasing the rate of ester hydrolysis. The concentration of such enzymes in the breaker fluid is typically 0.05 to 5% by weight for commercial liquid enzyme preparations and 0.005 to 0.5% by weight for dried enzyme preparations (based on the total weight of the breaker fluid).

At temperatures at or above 120° C., thermal hydrolysis of the ester may proceed at a sufficient rate such that there is no requirement for the addition of an ester hydrolysing enzyme or enzymes to the breaker fluid.

It may be preferred that the breaker fluid has a concentration of acid precursor of at least 1% by weight, in particular, at least 5% by weight, for example, a concentration in the range of 5 to 20% by weight (based on the total weight of the breaker fluid).

It may be preferred that the breaker fluid also incorporates enzymes to remove viscosifying and fluid control agents. For example, viscosifying and fluid control agents might be starches or xanthan gum.

In the case of a hydrocarbon production well, the breaker fluid may be removed by putting the well into production. In the case of an injection well, the breaker fluid may be removed by injection of a displacement fluid, e.g. water or a brine, into the well. Alternatively, a clean-up fluid may be circulated into the well to remove the breaker fluid. The clean-up fluid may be aqueous-based or oil-based.

Another aspect of the invention comprises a drilling mud comprising a base fluid comprising an aqueous phase containing up to 25% w/v, preferably, up to 20% w/v of a water soluble silicate, wherein the drilling mud has a particulate bridging solid suspended therein that is formed from a salt of a multivalent cation, wherein the salt of the multivalent cation is capable of providing dissolved multivalent cations when in the presence of an acid.

By way of example only, preparation of the drilling mud will now be described.

A concentrate comprising no more than 39% w/v of water soluble silicate, for example, sodium silicate and/or potassium silicate was diluted into a brine solution, e.g. a synthetic brine solution to provide a base fluid. The base fluid contains up to 25% w/v, preferably, up to 15% w/v of water soluble silicate. The pH of the solution was adjusted to 10 using pH control agents. Suitable pH control agents will be known to persons skilled in the art and examples are described above.

Typically, higher concentrations of water soluble silicate in the concentrate (above 39% w/v of water soluble silicate) are not preferred, because at such concentrations a paste may be formed.

Following dilution of the water soluble silicate in the brine solution, calcium carbonate and/or magnesium carbonate and/or dolomite particles are added, along with additional additives such as viscosifiers (for example, xanthan gum) and fluid loss additives (for example, starch).

The preferred concentration of silicate for a given application may be determined by reference to several factors thereby allowing the composition of the drilling mud to be optimized for a given application. These factors include the composition of the formation water, in particular the concentration therein of multivalent cations, especially divalent cations, and the initial permeability of the formation.

Typically, for formations of low initial permeability, the higher the multivalent cation concentration in the formation water, the lower should be the silicate concentration in the aqueous phase of the base fluid of the drilling mud. This is to avoid potential formation damage that might arise if the pore space of the formation became plugged with silicate precipitate (insoluble salts of the multivalent cations). This may be of concern for formations having an initial permeability of less than 750 mD, in particular, less than 500 mD.

In formations having a very high initial permeability, e.g., an initial permeability of greater than 750 mD, in particular greater than 1000 mD, the amount of silicate in the aqueous phase of the base fluid is independent of the multivalent cation concentration of the formation water. Thus, higher concentrations of silicate might be selected even in intervals where the formation water has a high multivalent cation concentration. This is because formations having a very high initial permeability have a lower risk of becoming plugged with silicate precipitate.

By way of example only, a method according to the invention will now be described.

After a site for a new wellbore has been identified, the wellbore is drilled using a drilling mud disclosed herein, e.g. prepared as described above. The wellbore penetrates an unconsolidated formation comprising sandstone.

Over-balanced drilling is employed. Accordingly, the pressure in the wellbore is greater than the formation pressure, thereby causing the base fluid of the mud to leak off into the formation (as filtrate) and a filter cake to form on the wellbore wail. The filter cake comprises particulate material such as particulate bridging solids, particulate weighting materials, and drill cuttings, and optionally other components of the drilling mud that become trapped in the filter cake such as polymers and emulsion droplets.

During drilling, the pH of the drilling mud is maintained above 7 (basic conditions), preferably above 9, to ensure that the water soluble silicate does not gel prematurely within the wellbore. This may mean that it is necessary to monitor the pH. Typically, the drilling mud will contain a base to ensure that the pH is kept at the preferred level.

After drilling, the aqueous breaker fluid containing an acid or acid precursor is introduced into the wellbore, e.g. by bullheading. The acid or the acid precursor in the breaker fluid can enter the pore space of the unconsolidated formation where the acid or the acid that is generated in situ from the acid precursor results in gelling of the silicate solution that has previously entered the pore space of the formation during the drilling operation. This gelled silicate will coat the surfaces of the sand grains of the formation and the surfaces of other fines that are present in the formation thereby increasing the consolidation of the formation.

The acid also reacts with the particulate bridging agent in the filter cake thereby dissolving the particles and generating dissolved multivalent cations. For example, where the particulate bridging agent is formed from calcium carbonate, magnesium carbonate or dolomite, the acid reacts with the particulate bridging agent to generate dissolved Ca²⁺ and/or Mg²⁺ cations, thereby dissolving the particulate bridging agent. Advantageously, the calcium carbonate, magnesium carbonate or dolomite particles produce CO₂ upon reaction with the acid. This CO₂, when dissolved in water, will be in equilibrium with carbonic acid and therefore assists in generating the acidic conditions required for gelation of the silicates.

The dissolved multivalent cations (for example, Ca²⁺ or Mg²⁺ cations) may enter the pore space of the unconsolidated formation owing to the pressure in the wellbore being greater than the formation pressure. The multivalent cations will react with silicate anions of the silicate solution, thereby generating a precipitate of an insoluble multivalent cation salt of the silicate (for example, calcium silicate and/or magnesium silicate). This precipitate will deposit on and/or intermingle with the gel, and will protect the gel against dissolving in an injection water (if the well is an injection well) or in a produced water (if the well is a production well).

Without wishing to be bound by theory, it is thought that the gelled silicate binds to the sand grains and other fines, and forms bridges between the individual sand grains and other fines, thereby consolidating the formation. In addition, the silicate precipitates (silicate salts of the multivalent cations) intermingle with and/or deposit onto, e.g. bind to and at least partially coat, the gel that coats the surface of the sand grains, thereby protecting the coating of gel from dissolving, or at least hindering the dissolution of the coating of gel, in water that is either injected into or produced from the formation.

Typically, a proportion of the insoluble silicate salts of the multivalent cations may deposit onto the rock surfaces (for example, sand grains and other fines that are coated with the gel).

Typically, the gelled silicates may be soluble in water. Thus, when the well is put onto production or injection, the gelled silicate that is not protected by the insoluble silicate salts of the multivalent ions will be displaced from the pore space, for example, by being dissolved in the produced or injected water. Typically, this unprotected gel will be non adhering gel that is present within the pore space of the formation. Accordingly, the interval will be consolidated without causing formation damage through plugging.

### Experimental

Laboratory tests were carried out using a porous ceramic disc (manufactured by Fann Instrument Company) measuring 2.5″ (6.35 cm) in diameter and 0.25″ (0.64 cm) in thickness and a nominal pore size of 3 μm. The disc was placed in a cell for performing a static breakthrough test and 80 g of 1000 mD artificial sand blend was deposited onto the disc.

A test drilling mud containing 15% w/v sodium silicate, 10 ppb of KCl, 0.5 ppb NaOH for pH control, 1.5 ppb of xanthan gum, 8 ppb of starch and 35 ppb of calcium carbonate and water was poured into the cell.

The static breakthrough test was then carried out in the cell, during which:
the leak off of the test mud over time was measured,
the excess mud from the porous disc was removed, and
the filter cake was soaked with a test breaker fluid at test temperature of 70° C. and test pressure of 100 psi for a period of between 24 hours to 1 week.

Experiments were carried out using test breaker fluids comprising 15% HCl and 10% formic acid in water respectively. For the test drilling mud, the breaker fluid comprising HCl tended to be more effective, although both performed adequately.

Following the static breakthrough test, the porous disc was taken out of the cell and inspected. It was found that the surface could be scratched, implying that the sand was not loose and had undergone some degree of consolidation.

The present invention makes it possible to consolidate weakly consolidated or unconsolidated formations after drilling and prior to completing a wellbore or an interval thereof. Beneficially, there may be no need to carry out a separate post-completion chemical consolidation. Further, the requirement for mechanical means for sand control such as a sandscreen may be reduced. Use of the drilling mud of the invention as a drill-in fluid may be particularly advantageous. Accordingly, the invention may provide significant cost and efficiency savings.

Many modifications may be made to the embodiments of the invention described herein without departing from the scope of the invention.

1-15. (canceled)

16. A method of strengthening subterranean formation by drilling and completing a wellbore penetrating at least one unconsolidated or weakly consolidated formation, the method comprising:
(a) drilling at least one interval of the wellbore that penetrates the unconsolidated or weakly consolidated formation using a drilling mud comprising a base fluid comprising an aqueous phase containing up to 25% weight by volume (% w/v), preferably, up to 20% w/v of a water soluble silicate, wherein the drilling mud has an acid-soluble particulate bridging solid suspended therein which is comprised of an ionic compound having a multivalent cation, wherein the salt of the multivalent cation is capable of providing dissolved multivalent cations when in the presence of an acid;
(b) subsequently introducing a breaker fluid containing an acid and/or an acid precursor into the wellbore;
(c) allowing the breaker fluid to soak in the interval that penetrates the unconsolidated or weakly consolidated formation for a predetermined period and strengthening formation by reacting with silicate now present in formation; and
(d) removing the breaker fluid.

17. A method as claimed in claim 16, further comprising drilling one or more further intervals of the wellbore.

18. A method as claimed in claim 16, wherein the predetermined period is up to 10 days.

19. A method as claimed in claim 16, wherein the base fluid comprises water or an oil-in-water emulsion having a continuous aqueous phase and a discontinuous oil phase.

20. A method as claimed in claim 16, wherein the water soluble silicate is an alkali metal silicate, e.g. a sodium or a potassium silicate.

21. A method as claimed in claim 19, wherein the water soluble silicate is an alkali metal silicate, e.g. a sodium or a potassium silicate.

22. A method as claimed in claim 20, wherein the water soluble silicate is a sodium silicate of the formula [Na₂O]x[SiO₂]y, where the ratio of y to x is in the range of from 2:1 to 7:2.

23. A method as claimed in claim 21, wherein the water soluble silicate is a sodium silicate of the formula [Na2O]x[SiO2]y, where the ratio of y to x is in the range of from 2:1 to 7:2.

24. A method as claimed in claim 16 wherein the aqueous phase of the base fluid contains at least 3% w/v, preferably, at least 5% w/v of water soluble silicate.

25. A method as claimed in claim 23 wherein the aqueous phase of the base fluid contains at least 3% w/v, preferably, at least 5% w/v of water soluble silicate.

26. A method as claimed in claim 16, wherein the drilling mud comprises one or more additional additives including viscosities, weighting agents, density increasing salts, fluid loss control agents, pH control agents, clay or shale hydration inhibitors, bactericides, solid and liquid lubricants, gas-hydrate inhibitors, corrosion inhibitors, defoamers, scale inhibitors, emulsified hydrophobic liquids such as oils, acid gas-scavengers, thinners, demulsifiers and surfactants.

27. A method as claimed in claim 16, wherein the pH of the drilling mud is maintained above 7, preferably above 9, during drilling.

28. A method as claimed in claim 25, wherein the pH of the drilling mud is maintained above 7, preferably above 9, during drilling.

29. A method as claimed in claim 16, wherein the particulate bridging solid is a carbonate of a multivalent cation.

30. A method as claimed in claim 25, wherein the particulate bridging solid is a carbonate of a multivalent cation.

31. A method as claimed in claim 29, wherein the particulate bridging solid comprises a carbonate selected from calcium carbonate and/or magnesium carbonate and/or dolomite.

32. A method as claimed in claim 30, wherein the particulate bridging solid comprises a carbonate selected from calcium carbonate and/or magnesium carbonate and/or dolomite.

33. A method as claimed in claim 16, wherein the breaker fluid is aqueous.

34. A method as claimed in claim 16, wherein the concentration of the acid and/or the acid precursor in the breaker fluid is at least 5% by weight based on the total weight of the breaker fluid.

35. A method as claimed in claim 33, wherein the concentration of the acid and/or the acid precursor in the breaker fluid is at least 5% by weight based on the total weight of the breaker fluid.

36. A method as claimed in claim 16, wherein the breaker fluid is removed by: in the case of a hydrocarbon production well, by putting the well into production; in the case of an injection well, by injection of a displacement fluid in the well; and/or by circulation of a clean-up fluid into the well.

37. A drilling mud comprising a base fluid comprising an aqueous phase containing up to 25% w/v, preferably, up to 20% w/v of a water soluble silicate, wherein the drilling mud has a particulate bridging solid suspended therein that is formed from a salt of a multivalent cation, wherein the salt of the multivalent cation is capable of providing dissolved multivalent cations when in the presence of an acid.
